(19) United States
(12) Patent Application Publication
(10) Pub. No.: US 2013/0246526 A1
(43) Pub. Date: Sep. 19, 2013

(54) Consensus and preference event scheduling

(71) Applicants: Nam Wu, San Jose, CA (US); Travis Terwilligar, San Jose, CA (US)

(72) Inventors: Nam Wu, San Jose, CA (US); Travis Terwilligar, San Jose, CA (US)

(21) Appl. No.: 13/423,261

(22) Filed: Mar. 18, 2012

(51) Int. Cl. G06F 15/16

(52) U.S. Cl. 709/204

(57) ABSTRACT

The invention described here utilizes the Internet and other communication and social media conduits to create a meeting or an event, with the specific details decided by consensus. This scheduling system streamlines, simplifies, broadens, and automates the process. The organizer initially creates a proposed event with a single or multiple date options. The organizer then adds candidate participants via social media accounts, for example: Facebook, Google+, LinkedIn; or other participant identifiers such as: email addresses, cellphone numbers, etc. Each created event can be altered until the specified end-date, the final date by which all participants may feedback their choices and preferences for this event.

### FIELD OF THE INVENTION

The present invention provides the ability to schedule an event, through a consensus process by correlating date, time, location, preference requirements, and other feedback to provide an optimal meeting.

### DESCRIPTION

The invention described here utilizes the Internet and other communication and social media conduits to create a meeting or an event, with the specific details decided by consensus. This scheduling system streamlines, simplifies, broadens, and automates the process. The organizer initially creates a proposed event with a single or multiple date options. The organizer then adds candidate participants via social media accounts, for example: Facebook, Google+, LinkedIn; or other participant identifiers such as: email addresses, cellphone numbers, etc. Each created event can be altered until the specified end-date, the final date by which all participants may feedback their choices and preferences for this event. In this patent disclosure we will refer to this consensus scheduling facility as EventWeaver (EW).

If the organizer chooses not to have multiple date options for the event then all participants that agree to the initial proposed parameters of the event are automatically invited to the event.

### BACKGROUND OF THE INVENTION AND PRIOR ART

Currently, there is no single tool available to help users plan an event through a voting/input consensus process for the meeting logistics and details: the system includes an optional weighted scale of the participant importance, optional automatic meal, menu, and restaurant selection, as well as automatically organizing for a target number of attendees. Employing all these elements allows for a meeting with much greater value to the participants. Other prior scheduling systems that are available in the market lack major components for creating an event through consensus and to allow a venue to be selected based on all the parameters and requirements of an event. There are many individual services offered today, but there is no facility to deliver the broad, complete, integrated, comprehensive, easy-to-use service offered in this invention. There are many significant vendors and products in the scheduling domain, some of the major players and services today are:

Microsoft Outlook Calendar, Lotus Notes Calendar, Evite—these calendaring services allow an event to be created, but the selected participants cannot vote or alter the time, date, other details, or venues. Furthermore, these services have no social media interactions, which include the ability to post the event results onto other social media sites, and the ability to invite participants through an external social media accounts.

Facebook, Socializr, EventBrite, MyPunchBowl, and Doodle—these facilities can create events and select venues, but they do not allow alternate dates or times and other parameters such as participants, menu, etc. to be suggested by the participants. The end-state of these services is to create an event but does not offer differing venues, as offered by external restaurant guides, such as Yelp or OpenTable.

Yelp, Venuetastic, OpenTable—these facilities can help with reservations at named events and venues, but they do not have any capabilities to select participants. These services are strictly a directory of restaurants and have no scheduling or voting capabilities.

Current email and telecommunications—these are the traditional methods to invite participants to an event but they do not have any ability to track feedback and assist the decision-making process.

Salesforce CRM, SugarCRM, Oracle CRM, and SAP CRM—have customer management capabilities, but they do have a platform to select candidate participants from public information or social media sources and create an event. These systems do not suggest venues, restaurants, menu, time, or date; they do not allow a consensus process.

Prior systems have generally specified mandatory attendees and optional attendees. Some of these systems employ weighted values in the optimization to select a spectrum of candidate participants and varying weights and to rank them aiding in limiting the invited to a quota. Prior systems have generally specified a specific meeting location, at specific times; EW can dynamically select and optimize these characteristics. Prior systems have not usually scheduled candidate participants from heterogeneous Internet site profiles; EW can employ multiple online, heterogeneous resources for input data, including mobile devices. Prior systems do not allow a target number of attendees to be specified and automatically selected.

### BRIEF DESCRIPTION OF THE DRAWINGS

FIG. 1. is a flow diagram of the scheduling process.

FIG. 2. is a diagram of a computer server system.

### DETAILED DESCRIPTION OF THE INVENTION

### Additional Embodiment Details

The term meeting organizer or facilitator is used in the context of this invention in the broadest possible meaning, comprising individuals or groups that are authorized in the EW facility to organize, sponsor, administer, or lead, the scheduling exercise. This role is responsible for initiating the scheduling process, and optionally supplying values to influence the scheduling algorithm.

The term candidate participants is used in the context of this invention in the broadest possible meaning, comprising all individuals or groups that may be suitable for inclusion in the event and in the scheduling exercise based on their accumulated profile data or designation.

The term Internet communication is used in the context of this invention in the broadest possible meaning comprising: Tweets, SMS (Short Message Service), texting, chat, e-mail, or other network based communication means to notify and solicit candidate participants or other methods of mass communication.

The term Internet websites or resources is used in the context of this invention in the broadest possible meaning comprising: websites, applications (apps), software, data processing, cloud processing, database data access, or other methods suitable for hosting and allowing the retrieval of information.

The term restaurant is used in the context of this invention in the broadest possible meaning comprising the full range of establishments that serve food or beverages. This includes the full range of coffee shops, fast food places, bars, ice cream stores, ‘roach coaches’, theaters, as well as conventional restaurants. In some circumstances venues such as halls, rooms, or public or private places that allow catering are included. These restaurants need not necessarily accept reservations.

The term meal is used in the context of this invention in the broadest possible meaning comprising the full range of all foods or beverages that might be consumed.

The term face to face is used in the context of this invention in the broadest possible meaning comprising individuals who are co-located, live in person; in some cases this may also be augmented or substituted by a virtual electronic face-to-face meeting.

The term food preference profile is used in the context of this invention comprising a facility to express the range of food preferences for an individual. This may include dietary restrictions, allergies, religious or other philosophical requirements, cooking requirements, and any other necessary food related considerations.

A meeting priority weight is used in the context of this invention comprising a subjective assigned weight or importance assigned to a candidate participant by the meeting facilitator for use by the system in choosing participants invited and other factors to maximize the success of the meeting.

A software program in the context of this invention comprising a series of computer logic programs and processes that may act as the meeting organizer, facilitator, or assistant. It may provide groupings or lists of suitable candidates meeting a set of criteria. Artificial intelligence techniques and Internet daemons may be used to facilitate groupings, data mining of web sites to discover suitable new candidates, and select candidate participants via algorithm or other selection techniques.

The objective of a meeting in the context of this invention in the broadest possible meaning comprising meeting topics such as: sales, or education, or dating, and other topics, or any other social interaction enhanced by a face to face meeting or a virtual face to face meeting experience.

A participant input capability is used in the context of this invention comprising data supplied to the scheduling system. This may include the full range information such as: proposed venues, time, date, etc., and interest notification, voting, or other input data that a candidate participant may supply via a feedback mechanism.

An external calendar is used in the context of this invention in the broadest possible meaning, comprising the full range of scheduling systems such as: Microsoft Outlook calendar, Google calendar, iCal calendar, Lotus Notes calendar, and other calendaring services provided internal to EW or by third-parties.

An information source is used in the context of this invention in the broadest possible meaning comprising data and parameters, which may include addresses, web site data, GPS locations, landmarks, etc.

Preference information is used in the context of this invention in the broadest possible meaning, comprising a list of data elements, including: time, date, location, and optional information such as: temperature, ambient light, indoor, or outdoor, and other data.

Scheduling information is used in the context of this invention in the broadest possible meaning, comprising the calendaring data available to the scheduling system relevant to event calendaring.

A target or maximum number of attendees is used in the context of this invention comprising the threshold for the number of candidates to be invited by the facilitator to provide the best quality result for the event.

A date range is used in the context of this invention in the broadest possible meaning, comprising the starting time and the end time boundaries to be applied in scheduling a specific event.

A scheduling and voting process is used in the context of this invention in the broadest possible meaning, comprising the process of receiving and employing input and votes from participants to be applied to the scheduling process.

Voting feedback is used in the context of this invention in the broadest possible meaning, comprising soliciting participant's feedback through the use of Internet web sites, smartphones, smartphone apps, stored data, mobile devices, or other electronic devices and inputting this to the scheduling process to optimize the final scheduling decisions.

An end-time or default end-time is used in the context of this invention comprising the use of a facilitator specified, or a default time, in the scheduling process to establish an ending boundary for the scheduling process.

The steps below describe one embodiment of the process by which an organizer creates an event through the EventWeaver (EW) facility:

The initial step in most embodiments of EW is creating an event in EW, is to create an account in EW facility. Upon the successful creation of the account, the organizer can immediately start creating an event.

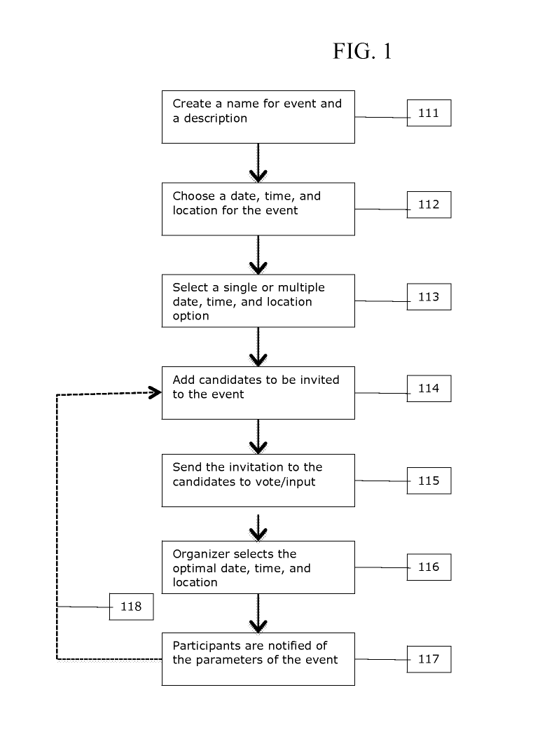

Event creation begins with the organizer providing [FIG. 1] a name for the event, a short description, and time and date selection (Diagram 111). The organizer can choose: 1) a specific date option by which he/she must select a specific date from the calendar, and a specific time for the event (Diagram 112). The organizer can also provide the location and the address of the location for the guest(s); or 2) multiple options for date, time, and location (Diagram 113). Once all the options are specified, the organizer chooses a list of guests (Diagram 114) via: social media sites for contacts, email addresses, phone numbers, SMS contacts, etc. The organizer may notify the participants by invitation (Diagram 115).

The organizer may choose a single date option, then there is no requirement to select a voting end-date since all participants may either attend, or they decline to attend the event. In this case, the organizer simply has to confirm with the participants and choose a venue to finalize the event.

The organizer may choose multiple date options, then a voting end-date is required to be specified, by which all participants can vote or submit feedback for the best possible details comprising: date, time, and location. The organizer may allow another participant to receive the organizer status; thus, allowing him/her to invite other guests or to view the overall voting process of the event.

Candidate participants have an optional “weight” given to each individual by the event organizer. By default, all candidates are set to ‘required.’ The weight score will determine the overall outcome of the voting process. For example, each guest will be given 5 weight scores (highest to lowest): required, great to see, nice to see, meet up next time, and optional. Individuals with highest weight score will bias the total percentages of the voting process.

All events created have the capabilities to allow participants to add comments to the event. The comments are means of communication between the organizer and the participants of this particular event.

Additional features of event creation comprise of: 1) setting a time range for the particular event—this is to set a start time and an end time to the event; 2) re-use a previous event that had all the parameters pre-determined except for the new time and date, and possibly the voting end-date; 3) event themes to set the background image of the invitation; 4) calendar synchronization capabilities to allow availability look-up in external calendars or to block off a calendar for any accepted event; and 5) externally-accessible application programming interface to allow third-party tools to utilize our services.

When an event has reached a voted state and the organizer has decided to proceed with the event an optional step of venue selection (Diagram 116). The organizer can choose comprising: 1) select a venue by stating the name and address; 2) push the event criteria to an external site to finalize with a date; 3) use a restaurant reservation service to book a table; 4) push the event criteria to an external customer resource management software to collaborate with customers; or 5) leave the option open for the guests to decide (options 1-5 are reflected in Diagram 117). However, if a consensus cannot be reached then a possible iterative process may be re-instated by the event organizer (Diagram 118).

The novelty in this invention is derived by the combination of factors: provide a single comprehensive fully automated rich function scheduling of a meeting where the participants, who may not know each other, are based on an algorithm considering and evaluating: their calendar availability, their social media and other website preferences and profiles, professional society profiles, their food preference profiles, their meeting priority weight, their geographic location and travel time, the meeting site evaluation and availability, as provided by online web guides and online reservation systems, and other information and factors. Event planning is accomplished through consensus voting/input by inviting participants via social media, email, cellphone apps, and other communication facilities. The voting/input process determines the best date, time, restaurant, and location and thus affecting the final decision of the venue and other parameters. The venue can be suggested by EW, influenced by optional advertising displayed to the organizer, or it can be selected by the organizer. If the organizer chooses, the individual can grant the organizer privilege to any participant. The objective is to provide optimal choices for the time, date, location, the number of participants to attend an event. The meeting facilitator may supply values that influence the scheduling algorithm.

The described techniques may be implemented as a method, or apparatus or article of manufacture involving software, firmware, micro-code, hardware and/or any combination thereof. The term “article of manufacture” as used herein refers to program instructions, code and/or logic implemented in circuitry (e.g., an integrated circuit chip, Programmable Gate Array (PGA), ASIC, etc.) and/or a computer readable medium (e.g., magnetic storage medium, such as hard disk drive, floppy disk, tape), optical storage (e.g., CD-ROM, DVD-ROM, optical disk, etc.), volatile and non-volatile memory device (e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.).

Code in the computer readable medium may be accessed and executed by a machine, such as, a processor. In certain embodiments, the code in which embodiments are made may further be accessible through a transmission medium or from a file server via a network. In such cases, the article of manufacture in which the code is implemented may comprise a transmission medium, such as a network transmission line, wireless transmission media, signals propagating through space, radio waves, infrared signals, etc. Of course, those skilled in the art will recognize that many modifications may be made without departing from the scope of the embodiments, and that the article of manufacture may comprise any information bearing medium known in the art. For example, the article of manufacture comprises a storage medium having stored therein instructions that when executed by a machine results in operations being performed.

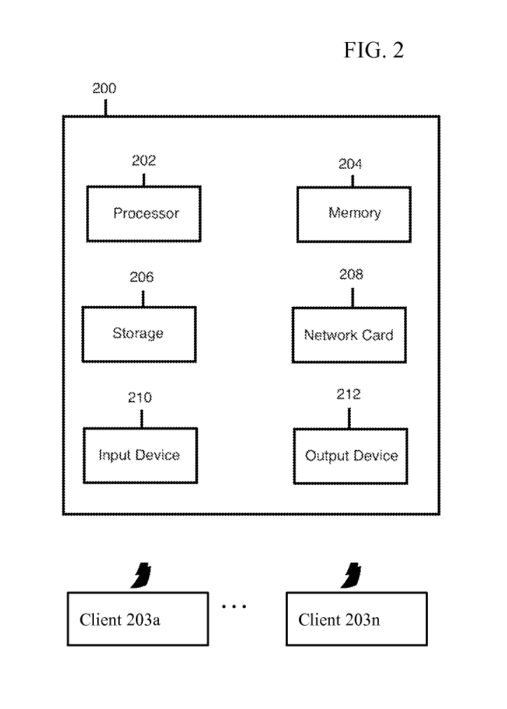

FIG. 2 illustrates a block diagram of a computer architecture 200 in which certain embodiments may be implemented. FIG. 2 illustrates one embodiment of a server 200 and the clients 203a . . . 203n (may be connected directly or via remote communications or cellular). The server system 200 may implement the computer architecture 200 having a processor 202, a memory 204 (e.g., a volatile memory device), and storage 206. Certain elements of the computer architecture 200 may or may not be found in the server 200. The storage 206 may include a non-volatile memory device (e.g., EEPROM, ROM, PROM, RAM, DRAM, SRAM, flash, firmware, programmable logic, etc.), magnetic disk drive, optical disk drive, tape drive, etc. The storage 206 may comprise an internal storage device, an attached storage device and/or a network accessible storage device. Programs in the storage 206 may be loaded into the memory 204 and executed by the processor 202. Additionally, the architecture may include a network card 208 to enable communication with a network. The architecture may also include at least one input device 210, such as, a keyboard, a touchscreen, a pen, voice-activated input, etc., and at least one output device 212, such as a display device, a speaker, a printer, etc.

At least certain of the operations of FIG. 2 may be performed in parallel as well as sequentially. In alternative embodiments, certain of the operations may be performed in a different order, modified or removed.

Furthermore, many of the software and hardware components have been described in separate modules for purposes of illustration. Such components may be integrated into a fewer number of components or divided into a larger number of components. Additionally, certain operations described as performed by a specific component may be performed by other components.

The data structures and components shown or referred to in FIG. 1 and FIG. 2 are described as having specific types of information. In alternative embodiments, the data structures and components may be structured differently and have fewer, more or different fields or different functions than those shown or referred to in the figures.

Therefore, the foregoing description of the embodiments has been presented for the purposes of illustration and description. It is not intended to be exhaustive or to limit the embodiments to the precise form disclosed. Many modifications and variations are possible in light of the above teaching.

1. A system and method to facilitate the scheduling of a meeting of participants with a common interest via a consensus process for selecting event details comprising: the date, time, location, and other event characteristics; wherein the planned meeting or event is intended to be primarily face to face; wherein the participants need not know each other, the scheduling system and method comprising:
a) The candidate participants each register information sources for their location, schedule, and preference information with one or more facilities accessible via Internet communications or wireless communication means comprising: Internet web sites, smartphone apps and stored data, pad or tablet apps and stored data, or other electronically accessible scheduling information;
b) The meeting organizer initiates a meeting scheduling process which comprises: a preliminary meeting objective, a preliminary candidate attendee list, a time, a date or date range, and a venue; and an optional target or maximum number of attendees may be specified;
c) The candidate participants information comprises: scheduling availability and preferences gathered from the information sources that the candidate participants have provided;
d) An invitation is sent via Internet or wireless communication means to each candidate participant soliciting feedback on the meeting details to be input to the scheduling process;
e) The meeting scheduling system optimizes the scheduling of the meeting based on the overall input, comprising: candidate participant availability, explicit preferences, gathered or specified information, and feedback; steps c through step e may be repeated;
The scheduling process is completed and finalized, and the participants are notified of the final details after the specified end-time or default end-time has passed.

2. In the scheduling system, as specified in claim 1, the meeting organizer specifies a subjective meeting priority weight for each candidate participant for this meeting objective; this is input to the scheduling algorithm; the scheduling system schedules the meeting to maximize the total meeting priority weight and preference values for the candidate participants.

3. The scheduling system, as specified in claim 1, employs a software program to act as, or to assist, the meeting facilitator in scheduling the meeting.

4. During the scheduling system process, as specified in claim 1, advertising from vendors for services and products are offered by the scheduling system to the facilitator, after determining suitable qualifications comprising: the geographic location or other matching characteristics.

5. Using the scheduling system, as specified in claim 1, wherein the planned meeting includes a meal: the scheduling system employs Internet resources comprising online restaurant guides, and online reservation systems to select the optimum available restaurant or meeting room as a meeting location, considering the candidates information and food preferences.

6. The scheduling system, as specified in claim 1, schedules remote audio or video connected session to allow remote participation to those not available for co-located meeting attendance.

7. The scheduling system, as specified in claim 1, automatically provides date, time, maps, directions, and itinerary, for the selected meeting venue.
